(19) United States
(12) Patent Application Publication
(10) Pub. No.: US 2009/0055442 A1
(43) Pub. Date: Feb. 26, 2009

(54) Management System for Contracts for Difference

(75) Inventor: Ajay Pabari, Northwood (GB)

Correspondence Address: Leason Ellis LLP, 81 Main Street, Suite 100, White Plains, NY, 10601, US

(73) Assignee: Spread Co Limited

(21) Appl. No.: 12/197,256

(22) Filed: Aug. 23, 2008

(30) Foreign Application Priority Data
Aug. 24, 2007 (GB) 0716586.3

(51) Int. Cl. G06F 17/30; G06Q 40/00; G06F 15/16

(52) U.S. Cl. 707/201; 705/35; 709/203; 707/E17.005

(57) ABSTRACT

A management system for contract for difference trading is disclosed. The system includes a user interface module and a processing module. The user interface module includes computer program code for receiving user inputs on a purchase or sale of a contract for difference and computer program code for communicating data to the processing module in dependence on said user inputs. The processing module comprises a machine executing computer program code that is arranged to receive the data communicated from the user interface, wherein if the data concerns a purchase, the computer program code is arranged to debit a financial account for the value of the contract for difference to be purchased, if the data concerns a sale, the computer program code is arranged to credit a financial account for the value of the contract for difference to be sold.

### FIELD OF THE INVENTION

The present invention relates to a management system for contract for difference (CFD) accounts.

### BACKGROUND TO THE INVENTION

A contract for difference is a contract between two parties, typically a trader (purchaser) and a broker (seller). The broker agrees to pay to the trader the difference between the value at the time of sale of an asset and its value at contract time. (If the difference is negative, then the buyer pays instead to the broker). For example, when applied to equities, such a contract is an equity derivative that allows investors to speculate on share price movements, without the need for ownership of the underlying shares.

Contract for difference accounts allow a user to speculate on the price movements of an individual share, commodity, foreign exchange or an index rather than buying the underlying security themselves. It is possible to take a ‘long’ position, betting the price will rise, or a ‘short’ position, betting the price will fall.

CFDs are traded on what is referred to as leverage. Leverage is typically expressed as a ratio such as 10 to 1, with some CFD brokers providing 20 to 1 leverage. For example, if you bought shares that returned a $1500 profit in one year, a corresponding purchase using a CFD could produce a $15000 profit due to the leverage factor.

Although they present an opportunity to make significant profits, the geared nature of CFDs means that a relatively small movement in price of the underlying security will result in a much larger movement in the value in the CFD. It is also possible to quickly lose more money than your initial deposit.

In order to provide some protection for the user, some providers offer limited risk facilities. For example, IG Markets' Limited Risk facility allows you to trade CFDs without assuming a potentially open-ended liability.

When you trade on a Limited Risk basis you specify a Guaranteed Stop level at which your position will be closed should the market move against you. It is guaranteed that the position will be closed at exactly your selected level, even if there is a very sharp overnight move. There is an extra charge, in effect an insurance premium, for Limited Risk protection. In most cases this is 0.3% of the underlying transaction value. Limited Risk protection is not available on all shares and the size of the position on which a provider may be able to offer this facility may be limited. The margin requirement for a Limited Risk trade is equal to the amount which would be lost if the Stop were triggered, plus 10% to cover any interest or dividend adjustments.

There also exist so-called “Listed CFDs”. These combine the flexibility of a CFD contract with the price transparency of a Stock Exchange listing.

Listed CFDs work just like the unlisted versions as they offer leveraged exposure to the underlying security. In order to gain exposure to a given asset such as a share or index, an investor is only required to put up a margin (typically between 5% and 15%) for the amount they wish to control.

This gives the investor the potential to make higher returns (if they get the direction of the trade right) than they would achieve from a direct investment in the asset. Of course, if the direction of the trade is wrong, a CFD trade will also magnify any losses. Just like an unlisted CFD, the listed version allows you to benefit from falling or rising markets.

One vital difference between a listed and unlisted CFD, however, is the fact that a listed CFD embeds a guaranteed stop loss at no extra cost. You can never lose more than your initial margin payment when you trade a listed CFD, no matter how badly markets move against you. In other words, only listed CFDs offer unlimited upside, with strictly limited downside.

All pricing and trading in listed CFDs is overseen by the London Stock Exchange. This ensures greater price transparency and better counterparty protection for an investor compared to an unlisted CFD, which is a direct contract with a financial entity.

The provider of an unlisted CFD will require you to maintain the margin level throughout the life of the trade. This may require additional margin payments, which can often come at the most unwelcome time—when a trade is moving against you.

No additional margin payments are required for listed CFD positions. Even if the trade moves against you, you may keep the position open until the stop-loss level is hit. In this event, however, the position is automatically closed out. Any remaining financing component of a listed CFD price is lost when a stop-loss event occurs and therefore you will get back less than if you sold the listed CFD at the equivalent market price to the stop-loss price.

When you are holding a long CFD you are purchasing securities on margin and incur a financing fee on the amount you borrow. For unlisted CFDs, this fee is charged to your account on a weekly or daily basis, which makes it difficult to identify the true cost of the trade when taking out your position.

For listed CFDs, however, all financing fees and dividend payments are included in the initial price. The value of a listed CFD is reduced by a fixed amount overnight to reflect the daily financing fee, with no additional payments required. Similarly, any financing fees you are due to receive from a short position or dividend payments you are required to make, are factored into the price of the listed CFD.

In contrast to many CFD providers with high minimum trade sizes, you can open just one contract for one share with SG Listed CFDs. The standard contract size on the FTSE 100 index is just 1 GBP a point. This gives the investor far greater flexibility to trade small and large positions and much more precision in putting on the appropriate sized trade for their risk appetite.

A typical unlisted CFD provider will charge you 0.25% of the full trade value. For example, if you were to purchase £100,000 of a FTSE 100 position (which may require a 10% margin payment of £10,000), you would be charged a hefty £100,000×025%=£250.

For SG Listed CFDs, however, you only pay commission on the amount of margin you pay. In the above case, you would only pay commission on the £10,000 margin payment, for which most online brokers will charge a flat fee in the region of £10 to £25. Overall commission trading costs on listed CFDs can therefore be more than 10× cheaper than unlisted ones.

Whilst listed and limited risk CFDs are attractive to the investor, they both have disadvantages. The problems with limited risk facility include that they operate by function of payment of a margin, there can be an extra charge made to the clients account for this facility, the facility may not be available on all shares, the size of the position that is available for can be limited, there is generally no facility for the client to change the stop loss level once placed, it works on the same concept as standard CFD's, and the margin requirement is the maximum required for the guaranteed stop level specified plus 10%.

The problems with listed CFD's include that they operate by function of payment of a margin, they are available only during London Stock Exchange trading hours of 08:00 to 16:30, they are only available for a limited number of shares and one index, they are only available as forward quarterly contracts, the gearing is set by the provider with no flexibility to the customer, the gearing is different for each instrument, there is no facility for the client to change the stop loss level which is set by the provider, there is no possibility to trade overseas stocks, there is no possibility to trade currency, commodities or bullion, and it is only available through stockbrokers.

### STATEMENT OF INVENTION

According to an aspect of the present invention, there is provided a A management system for contract for difference trading comprising:
a user interface module and a processing module,
the user interface module including computer program code for receiving user inputs on a purchase or sale of a contract for difference and computer program code for communicating data to the processing module in dependence on said user inputs;
the processing module comprising a machine executing computer program code that is arranged to receive the data communicated from the user interface,
wherein if the data concerns a purchase, the computer program code is arranged to debit a financial account for the value of the contract for difference to be purchased, if the data concerns a sale, the computer program code is arranged to credit a financial account for the value of the contract for difference to be sold.
The processing module may further comprise computer program code that is arranged to obtain security pricing data from a data source, computer program code that is arranged to calculate contract for difference value data in dependence on the obtained security pricing data, and computer program code that is arranged to communicate the calculated contract for difference value data to the user interface module; and,
the user interface module may further comprise computer program code for communicating with the processing module for receiving the contract for difference value data on securities from the processing module and computer program code for displaying a user interface to a user including the value data.

The management system may further comprise a data repository, the data repository comprising a data store for storing data on a user account and on a purchased contract for difference associated with the user account, wherein the processing module is arranged to store or update data in said data repository in dependence on said data received from the user interface.

The data repository is preferably arranged to store data on a stop loss level for a contract for difference, the processing module further comprising computer program code for calculating the value of the purchased contract for difference in dependence on the value data and computer program code for closing the purchased contract for difference if said value is less than or equal to the stop loss level.

The user interface module may include computer program code for accepting a change to the stop loss level and computer program code for communicating data on said change to the processing module, the processing module further comprising computer program code for updating the stored stop loss level data in the repository in dependence on the data from the user interface and computer program code for crediting or debiting said financial account in dependence on said change.

The computer program code for accepting a change may include computer program code for displaying a funds withdrawal user interface element in association with a purchased contract for difference and computer program code for receiving a user input to the funds withdrawal user interface element requesting funds withdrawal from the associated contract for difference.

The computer program code for accepting a change may include computer program code for displaying an additional funding interface element in association with a purchased contract for difference and computer program code for receiving a user input to the additional funding interface element designating additional funding for the associated contract for difference.

The data repository may store data on a global stop loss level that applies to all of an account's contracts for difference unless wherein the user interface module includes computer program code for accepting a user input to set an individual stop loss level for a contract for difference, said individual stop loss level overriding the global stop loss level.

The user interface module may include computer program code for displaying a stop loss disable user interface element in association with a purchased contract for difference and computer program code for accepting a user input to the stop loss disable user interface element and for communicating data on said user input and said associated contract for difference to the processing module, the processing module further comprising computer program code for receiving said data on said user input and on said associated contract for difference, computer program code for applying a charge to said financial account and computer program code for removing or disabling said stop loss level for the contract for difference in said data repository.

The processing module may further comprise computer program code for adjusting data on a contract for difference held open after an end of day cut-off time, said adjustment being operative to reduce a next day opening value for the contract for difference in dependence on a predetermined charge.

The management system may comprise a web server hosting the user interface.

The management system may further comprise a network interface coupled to the processing module, wherein the user interface is remote of the processing module and is arranged to communicate with the processing module via the network interface over a data communications network.

In one embodiment, a method of managing a contract for difference comprises offering a contract for difference for sale or for purchase as a security, wherein the purchase price and sale price is determined by reference to the level of leverage and the price of the underlying security.

The resultant contract for difference, referred to hereafter as a Premium CFD has numerous advantages over conventional (margin) CFDs such as discussed above. These advantages are discussed below.

The key feature that differentiates Margin CFD's from Premium CFDs is that for Margin CFD's the deal is only valued and the margin settled to the account when the position is closed (when a long position is finally sold or when a short position is purchased to balance a previous sale). The margin is the difference between the opening price and closing price. At purchase time in a conventional, margin, CFD, a marker is created that identifies the position. Unless there are credit rating risks, no monies typically change hands at this stage. However, as valuation of the margin only happens at the close of the position it is not unusual for the client to be surprised at the cost of a failed position at its close (which he or she is contractually bound to settle). In the presently claimed invention, the client pays a purchase price for buying the Premium CFD (by buying we refer to purchase of a short or long position). The purchase price is then debited from his account (note that if it is a short position then the purchase price would be negative so the net effect would be a credit to the account). The CFD position at that point is essentially owned by the client in the same way underlying security would be in a regular share based trade. When the position is closed, the selling price is credited to the account (again note that in a short position this could be a negative sale price which would have a net result of debiting the account).

A leverage factor for each product is calculated to determine the purchase price. Due to this, the client will have to accept levels of the standard and guaranteed stop levels which are inherent in the security purchased and under normal circumstances would be unable to choose their own stop levels.

In a preferred embodiment of the present invention, the method includes the step of accepting a request and funds from a client to set their own stop loss level by ‘topping-up’ their purchase price after a CFD purchase.

In another preferred embodiment of the present invention, the method includes the step of accepting a request from a client to withdraw a portion of their investment from the original purchase price of a pending CFD. In response to the request, a portion of the originally paid premium is refunded to the client and the standard and guaranteed stop levels are reduced in dependence on the remaining investment.

In embodiments of the present invention, a CFD can be purchased as a security and not operated by payment of a margin. Clients will have the opportunity to participate in the price performance of any equity security, index, foreign exchange or commodity by purchasing a structured security with an in-built in stop loss feature to limit the maximum downside risk to the purchase price. In the preferred embodiment discussed above, the client will additionally have the ability to choose where they would like the stop loss to be by paying an additional premium. The structured security will be priced by reference to an underlying security and can be closed at any time, when the markets are open for trading to realize the value of the security.

Other optional features that can be included in one or more systems in accordance with the foregoing that that the gearing inherent in the CFD may be set by the provider however an option will exist whereby this can also be determined by the client, and that a comprehensive range of markets can be available to be traded.

The charging process is different for shares and indices and foreign exchange trades.

Several advantages can result from a system in accordance with the invention including that clients will know in advance the maximum downside risk when purchasing a Premium CFD, clients will have the option to set a stop loss of their choice by payment of an additional premium, clients will not lose more then their initial purchase price and any additional premium, there are no extra charges for protecting the downside risk, there are no extra funds required in client's account to pay financing costs and corporate actions, it is available on a wide range of products including equities, indices, commodities, foreign exchange and bullion, it is available on overseas equities, it is available as cash or spot contracts and as forward contracts, and the gearing is defaulted to a standard level per instrument, but can be changed to be determined by the client. One noted disadvantage is that there is no partial closure of any contract; rather, the contract has to be closed in full.

### BRIEF DESCRIPTION OF THE DRAWINGS

Embodiments of the present invention will now be described in detail by way of example only with reference to the accompanying drawing, in which:

FIG. 1 is a schematic diagram of a management system according to an embodiment of the present invention.

### DETAILED DESCRIPTION

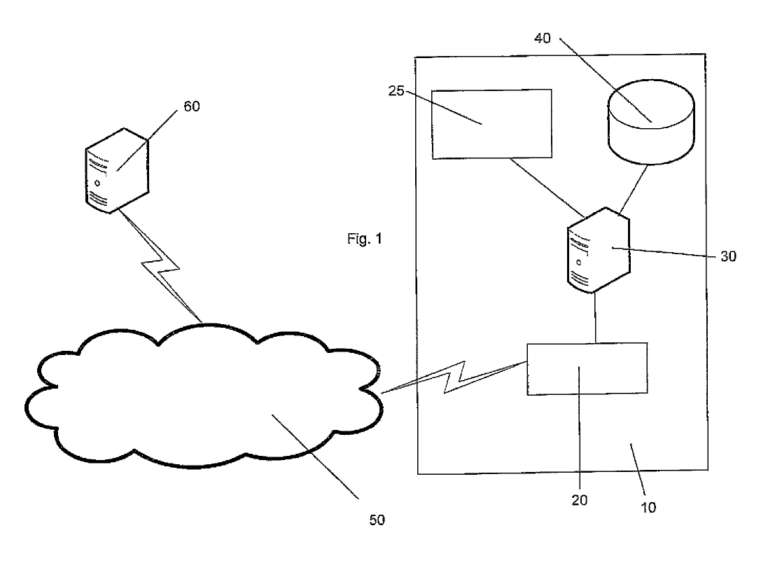

FIG. 1 is a schematic diagram of a management system for contracts for difference according to an embodiment of the present invention.

The management system 10 includes a network interface 20, a user interface module 25, a processing module 30 and a data repository 40. The modules include computer program code (“software”) that executes on a processor of a machine to cause the machine to perform a set of instructions embodied in each module.

A user accesses the management system 10 via the user interface module 25. The user interface module 25 may be local to the user on a client device/machine or it may be remote (such as provided on a website). The management system 10 is connected to a data communications network 50 such as the Internet via the network interface 20. The user interface module 25 is arranged to receive inputs from the user and is arranged to communicate with the processing module 30 and the data repository 40.

A new user registers with the management system 10 via the user interface module 25 in order to open an account. Existing users log on to their account via the user interface module 25.

A user accessing his or her account via the user interface module 25 accesses data corresponding to his or her respective account in the data repository 40. The data relates to current active contracts for difference (referred to herein as positions) and may also relate to historic positions which were closed or otherwise sold.

A user accessing his or her account via the user interface module 25 may modify or close current active positions and/or purchase new positions.

Costs, profits and losses associated with positions are calculated by computer program code executing on the processing module 30 which accesses current prices on a remote data source 60. These are then presented to the user via the user interface module 25. The prices on the remote data source 60 are dynamically changing whilst the respective market on which the security is listed is open. The processing module therefore monitors these prices and updates its local calculations in order to present the changing information to the user via the user interface.

The user pays a purchase price for buying a position in a respective product which is then debited from his account. The processing module 30 calculates the price in dependence on the inputs of the user from the user interface module 25 and in dependence on the current price for the underlying security obtained from the remote data source 60. The processing module 30 thus operates on data and transforms the inputs into new values on the basis of current share price—a dynamic parameter, and optionally other data.

Data on the purchase is recorded in the repository against a record for an active position. When the position is closed, the selling price is calculated based on the data in the repository and on the current price for the underlying security obtained from the remote data source 60. The sale price is credited to the account and the data repository is updated accordingly.

A leverage factor for each product is predetermined and is a factor in the purchase price. Due to the leverage factor, the user will have to accept levels of standard and guaranteed stop levels which are inherent in the security type purchased. Under normal circumstances, a user is unable to choose his or her own stop levels, although he or she may be given the option to change these, as is discussed in detail below.

Various examples of leverage factors and purchase and sale prices for different products are discussed below:

### Shares and Indices

The Purchase Price (p) of a share or index based position is calculated as follows:

$$p = U * \frac{O}{L} * IPC$$

### Where:

U=number of units to be purchased in the CFD
O=OpeningPrice—For long position the offer price and for short position the bid price of the CFD—these are obtained from the remote data source 60
L=Leverage—The set leverage for the security
IPC=InstumentPointConvention—the ratio between the price quoted for the instrument and the currency unit. For UK shares quoted in pence it is 0.01. UK indices are quoted in pounds so for these it is 1. This is set up in the instrument definition for each product.

The processing module obtains the opening price from the remote data source 60 and stores it in a memory register. The leverage and IPC are typically stored in the data repository and the relevant values are obtained and stored in further memory registers. Finally, the number of units is obtained from the user interface and a multiplication operation is performed on the contents of the memory registers to calculate the purchase price. Upon purchase the purchase price is stored in the data repository.

The Sale Price (s) of is calculated as follows:

s=U*(Pu+Pr+adj)*IPC

where
U=number of units to be sold in the CFD
Pu=The purchase price per unit of the CFD/Leverage Factor
Pr=The sale price less the purchase price per unit of the CFD
adj=Accumulated Financing (negative for long positions and positive for short positions) and Corporate Action (positive for long positions and negative for short positions) adjustment
IPC=InstumentPointConvention, the ratio between the price quoted for the instrument and the currency unit. For UK shares quoted in pence it is 0.01. UK indices are quoted in pounds so for these it is 1. This is set up in the instrument definition for each product.

The processing module obtains the sale price from the remote data source 60 and stores it in a memory register. The purchase price and IPC are typically obtained from the data repository and the relevant values are obtained and stored in further memory registers. Finally, the number of units is obtained from the user interface and an addition followed by a multiplication operation is performed on the contents of the memory registers to calculate the sale price.

For Intra-day calculations and End Of Day calculations, where the position is still open, we calculate the Value of Position instead of the Sale Price to determine the Account Valuation after a position is opened and the Value Of Position (v) is calculated as follows:

v=Nu*(Pu+Pr+adj)*IPC

where:
Nu=NetUnits, net position in the CFD. This will be positive for long and short positions.
Pu=PurchasePricePerUnit, The purchase price per unit of the CFD/Leverage Factor
Pr=ProfitPerUnit, The mid closing price per unit less the purchase price per unit of the CFD
adj=Accumulated Financing (negative for long positions and positive for short positions) and Corporate Action (positive for long positions and negative for short positions) adjustment
IPC=InstumentPointConvention, the ratio between the price quoted for the instrument and the currency unit. For UK shares quoted in pence it is 0.01. UK indices are quoted in pounds so for these it is 1. This is set up in the instrument definition for each product.

The processing module obtains the mid closing price from the remote data source 60 and stores it in a memory register. The purchase price, net units and IPC are obtained from the data repository and the relevant values are stored in further memory registers. An addition followed by a multiplication operation is performed on the contents of the memory registers to calculate the valuation.

### Foreign Exchange (FX)

The Purchase Price (p) of a FX CFD is calculated as follows:

$$p = \frac{U}{L}$$

where:
U=Number of units of the first currency of the trade
L=Leverage set leverage for the security

The processing module obtains the leverage from the data repository and stores it in a memory register. Finally, the number of units is obtained from the user interface and a division operation is performed on the contents of the memory registers to calculate the purchase price. Upon purchase the purchase price is stored in the data repository.

The Sale Price (s) of a Premium CFD is calculated as follows:

$$s = p + U * \frac{Pr + adj}{Cp}$$

where:
p=Purchase Price of the opening trade
U=Number of units of the first currency of the trade
Pr=The sale price less the purchase price per unit of the CFD
adj=Accumulated Rollover adjustment

The processing module obtains the sale price from the remote data source 60 and stores it in a memory register. The purchase price is obtained from the data repository and the number of units is obtained from the user interface. These are stored in further memory registers. An addition operation followed by a division and then a multiplication operation is performed on the contents of the memory registers to calculate the sale price.

For Intra-day calculations and End Of Day calculations, where the position is still open, we calculate the Value of Position instead of the Sale Price to determine the Account Valuation after a position is opened and the Value Of Position (v) is calculated as follows:

$$v = p + U * \frac{Pr + adj}{Mp}$$

where
Pr=Purchase Price of the opening trade
U=Number of units of the first currency of the trade
Pr=The current mid price less the purchase price per unit of the CFD
adj=Accumulated Rollover adjustment Per Unit
Mp=The current mid price for the currency pair

The processing module obtains the mid price from the remote data source 60 and stores it in a memory register. The purchase price and units are obtained from the data repository and the relevant values are stored in further memory registers. An addition followed by a division operation is performed. The result is stored in a memory register and a multiplication operation followed by an addition is performed on the contents of the memory registers to calculate the valuation.

### EXAMPLES

For all the following examples we will assume that all the transactions will be made on a client account which has deposited $20,000 as initial funding on the account.

Assume for all account conversions, GBP:USD rate=2.0000

Assume that the leverage factors are as follows:

| | |
|---|---|
| Equities | 20:1 |
| Index | 50:1 |
| FX | 50:1 |

### Equities—Long Trade

Client buys 2,000 shares VOD N-M CFD, share price, as obtained from the remote data source 60 (which in this case will be the share listing) is quoted as 135.80−136.00.

$$p = U * \frac{O}{L} * IPC$$

Purchase Price (p)=2000*136.00/20*0.01=GBP 136.00

Financing charge per share per day 0.028

Assume at the end of day 1, VOD mid price closed at 140.00, client position still open.

### Client Account:

| | | |
|---|---|---|
| Cash | $19,728.00 | (20,000 − 272) |
| Valuation | $430.88 | 2000 * [6.8 + 4.00 − 0.028] * 0.01 * 2.0000 |
| Equity | $20.158.88 | |

After 7 days, client closes the trade by selling 2000 shares VOD N-M CFD at 143.50

s=U*(Pu+Pr+adj)*IPC

Sale Price (s)=136+2000*((143.50−136.00)−(7*0.028))*0.01=GBP 282.08 or USD 564.16

### Client Account:

| | | |
|---|---|---|
| Cash | $20,292.16 | (19,728.00 + 564.16) |

### Equities—Short Trade

Client sells 2,000 shares VOD N-M CFD, share price quoted as 135.80−136.00.

$$p = U * \frac{O}{L} * IPC$$

Purchase Price (p)=2000*135.80/20*0.01=GBP 135.80

Financing credit per share per day=0.013

Assume at the end of day 1, VOD mid price closed at 140.00, client position still open.

### Client Account:

| | | |
|---|---|---|
| Cash | $19,728.40 | (20,000.00 − 271.60) |
| Valuation | $168.52 | 2000 * [4.2 + 0.013)] * 0.01 * 2.0000 |
| Equity | $19.896.92 | |

After 7 days, the position is stopped by buying 2000 shares VOD N-M CFD at 141.30

s=U*(Pu+Pr+adj)*IPC[

Sale Price (s)=136+2000*((135.80−141.30)+(7*0.013))*0.01=GBP 27.82 or USD 55.64

### Client Account:

| | | |
|---|---|---|
| Cash | $19,783.64 | (19,728.00 + 55.64) |

### Index—Long Trade

Client buys 10 FTSE N-M CFD, index price quoted as 6,600−6602.

$$p = U * \frac{O}{L} * IPC$$

Purchase Price (p)=10*6602150*1=GBP 1,320.40

Financing charge per index per day=1.357

Assume at the end of day 1, FTSE mid price closed at 6,640, client position still open.

### Client Account:

| | | |
|---|---|---|
| Cash | $17,359.20 | (20,000 − 2,640.80) |
| Valuation | $3,373.66 | 10 * [132.04 + 38.00 − 1.357] * 1 * 2.0000 |
| Equity | $20,732.86 | |

[ValueOfPositions = NetUnits * (PurchasePricePerUnit + ProfitPerUnit + AdjustmentPerUnit) * InstrumentPointConvention]

After 7 days, client closes the trade by selling 10 FTSE N-M CFD index at 6665

s=U*(Pu+Pr+adj)*IPC Sale Price (s)=1,320.40+10*((6665−6602)−(10*7*1.357))*1=GBP 1,855.41 or USD 3,710.82

### Client Account:

| | | |
|---|---|---|
| Cash | $21,070.02 | (17,359.20 + 3,710.82) |

### Index—Short Trade

Client sells 10 FTSE N-M CFD, index price quoted as 6,600−6602.

$$p = U * \frac{O}{L} * IPC$$

Purchase Price (p)=10*6600/50*1=GBP 1,320.00

Financing credit per index per day=0.633

Assume at the end of day 1, FTSE mid price closed at 6,640, client position still open.

### Client Account:

| | | |
|---|---|---|
| Cash | $17,360.00 | (20,000 − 2,640) |
| Valuation | $1,852.66 | 10 * [132 − 40.00 + 0.633] * 1 * 2.0000 |
| Equity | $19,212.66 | |

After 7 days, client closes the trade by selling 10 FTSE N-M CFD index at 6665

s=U*(Pu+Pr+adj)*IPC[

Sale Price (s)=1,320.00+10*((6600−6665)+(10*7*0.633))*1=GBP 714.31 or USD 1,428.62

### Client Account:

| | | |
|---|---|---|
| Cash | $18,788.62 | (17,360.00 + 1,428.62) |

### FX—Long Trade

### Day 1—No Trade

| Client a/c | GBP | USD |
|---|---|---|
| Cash | 10,000 | 20,000 |

Client buys 100,000 GBPUSD @ 1.9000

[PurchasePrice=Units/Leverage] Always in the currency of the first currency

Purchase Price=100,000/50 GBP=GBP 2,000

### Day 1—After Trade

| Client a/c | GBP | USD |
|---|---|---|
| Cash | 8,000 | 16,000 |
| Valuation | 2,000 | 4,000 |
| Equity | 10,000 | 20,000 |

Assume at the end of day 1 the trade is still open and the rate for GBPUSD is 1.9100

### End of Day 1

| Client a/c | GBP | USD |
|---|---|---|
| Cash | 8,000 | 16,000 |
| Valuation | 2,500 | 5,000 |
| Equity | 10,500 | 21,000 |

ValueOfPositions = PurchasePrice + UnitsOfFirstCurrecy *
(ProfitPerUnit + AdjustmentPerUnit)/MidPriceofTrade
$\begin{matrix}Valuation = 100 ¸000 / 50 + 100 ¸000 * ( 1.9100 - 1.9000 ) / 2.000 \\ = 2000 + 500 \\ = GBP 2 ¸500\end{matrix}$

### Start of Day 2

Assume the rollover on this trade resulted in a net credit of USD 10 for the open position.

This rollover credit will not be credited to the client account as in Margin CFD, however, used as an adjustment of the opening price for the valuation calculation

| Client a/c | GBP | USD |
|---|---|---|
| Cash | 8,000 | 16,000 |
| Valuation | 2,505 | 5,010 |
| Equity | 10,505 | 21,010 |

$\begin{matrix}Valuation = 100 ¸000 / 50 + 100 ¸000 * ( 1.9100 - 1.9000 ) / 2.000 + 10 / 2 \\ = 2000 + 500 + 5 \\ = GBP 2 ¸505\end{matrix}$

Assume at the end of day 2 the trade is still open and the rate for GBPUSD is 1.9250

### End of Day 2

| Client a/c | GBP | USD |
|---|---|---|
| Cash | 8,000 | 16,000 |
| Valuation | 3,255 | 6,500 |
| Equity | 11,255 | 22,500 |

ValueOfPositions = PurchasePrice + UnitsOfFirstCurrecy *
(ProfitPerUnit + AdjustmentPerUnit)/MidPriceofTrade
$\begin{matrix}Valuation = 100 ¸000 / 50 + 100 ¸000 * ( 1.9250 - 1.9000 ) / 2.000 + 10 / 2 \\ = 2000 + 1250 + 5 \\ = GBP 3 ¸255\end{matrix}$

### Start of Day 3

Assume the rollover on this trade resulted in a net credit of USD 10 for the open position.

Client Sales 100,000 GBPUSD @ 1.9400

| Client a/c | GBP | USD |
|---|---|---|
| Cash | 8,000 | 16,000 |
| Sale Price | 4,010 | 8,020 |
| Final Cash | 12,010 | 24,020 |

$\begin{matrix}Sale Price = 100 ¸000 / 50 + 100 ¸000 * ( 1.9400 - 1.9000 ) / 2.000 + 20 / 2 \\ = 2000 + 2 ¸000 + 10 \\ = GBP 4 ¸010\end{matrix}$

### FX—Short Trade

### Day 1—No Trade

| Client a/c | GBP | USD |
|---|---|---|
| Cash | 10,000 | 20,000 |

Client sells 100,000 GBPUSD @ 1.9000

### Day 1—After Trade

| Client a/c | GBP | USD |
|---|---|---|
| Cash | 8,000 | 16,000 |
| Valuation | 2,000 | 4,000 |
| Equity | 10,000 | 20,000 |

Assume at the end of day 1 the trade is still open and the rate for GBPUSD is 1.9100

### End of Day 1

| Client a/c | GBP | USD |
|---|---|---|
| Cash | 8,000 | 16,000 |
| Valuation | 1,500 | 3,000 |
| Equity | 10,500 | 21,000 |

$\begin{matrix}Valuation = 100 ¸000 / 50 + 100 ¸000 * ( 1.9000 - 1.9100 ) / 2.000 \\ = 2000 - 500 \\ = GBP 1 ¸500\end{matrix}$

### Start of Day 2

Assume the rollover on this trade resulted in a net debit of USD 12 for the open position.

This rollover charge will not be debited to the client account as in Margin CFD, however, used as an adjustment of the opening price for the valuation calculation

| Client a/c | GBP | USD |
|---|---|---|
| Cash | 8,000 | 16,000 |
| Valuation | 1,494 | 2,988 |
| Equity | 9,494 | 18,988 |

$\begin{matrix}Valuation = 100 ¸000 / 50 + 100 ¸000 * ( 1.9000 - 1.9100 ) / 2.000 - 12 / 2 \\ = 2000 - 500 - 6 \\ = GBP 1 ¸494\end{matrix}$

Assume at the end of day 2 the trade is still open and the rate for GBPUSD is 1.9250

### End of Day 2

| Client a/c | GBP | USD |
|---|---|---|
| Cash | 8,000 | 16,000 |
| Valuation | 744 | 1,488 |
| Equity | 8,744 | 17,488 |

$\begin{matrix}Valuation = 100 ¸000 / 50 + 100 ¸000 * ( 1.9000 - 1.9250 ) / 2.000 - 12 / 2 \\ = 2000 - 1250 - 6 \\ = GBP 744\end{matrix}$

### Start of Day 3

Assume the rollover on this trade resulted in a net debit of USD 12 for the open position.

Client get liquidated and Sales 100,000 GBPUSD @ 1.9380

| Client a/c | GBP | USD |
|---|---|---|
| Cash | 8,000 | 16,000 |
| Sale Price | 88 | 176 |
| Final Cash | 8,088 | 16,176 |

$\begin{matrix}Sale Price = 100 ¸000 / 50 + 100 ¸000 * ( 1.9000 - 1.9380 ) / 2.000 - 24 / 2 \\ = 2000 - 1 ¸900 - 12 \\ = GBP 88\end{matrix}$

The purchase and sale price are required to be presented to the user in the currency of their account. So we calculate the purchase or valuation or sale price as above and convert this to the currency of the account to present to the user in the deal ticket via the user interface module 25. In this way the account holder will not be exposed to any exchange rate differences. All transactions will be performed in the currency of the account.

Preferably, all positions sold have a standard stop loss and a guaranteed stop loss built in.

The standard stop loss is set at 40% of the Adjusted Purchase Price for Equity CFD's and at 10% of the Adjusted Purchase Price for Commodity CFD's and at 2% of the Adjusted Purchase Price for FX, Bullion, and Index CFD's.

### Stop Loss Calculation

The stop loss will be calculated as per a configured profile stored in the repository 40 and associated with the user's account. The profile would be configured with any pre-agreed non-standard leverage and stop loss %.

For every position, an indicative stop loss level price can also be pre-set via the user interface module 25 and stored in the repository 40.

The movement in contract market price and exchange rate would affect the stop loss level price. For example, the valuation of a long GBPJPY position in an USD account would drop, if GBPJPY drops or GBPUSD gains strength (remember we value SS on first currency).

### Indicative Stop Loss Price

Optionally, the user interface module 25 may allow the setting of an indicative stop loss price at which the position would be closed to avoid further loss. The indicative stop loss market level price needs to be shown in the user interface module 25 along side the position with the live exchange rate.

As we need to accommodate live exchange rate, to get indicative stop loss price, we calculate as

### FX

### Long Position

Indicative SSL=open·price−{[((Investment amount/UnitsOffirstcurrency)*Account Exchange rate)+cumulative adjustment per unit]*configured SSL %}

ROUNDUP (EX. GBPUSD SSL=1.53116 or 1.53111, roundup 1.5312)

### Short Position

Indicative SSL=open·price+{[((Investment amount/UnitsOffirstcurrency)*Account Exchange rate)+cumulative adjustment per unit]*configured SSL %}

ROUNDDOWN (EX. GBPUSD SSL=1.53116 or 1.53112, rounddown 1.5311)

### Equity/Indices

### Long Position

Indicative SSL=open·price−{[((Investment amount/Units/IPC)*Account Exchange rate)+cumulative adjustment per unit]*configured SSL %}

ROUNDUP (EX. VOD SSL=101.53116 or 101.53678, roundup 101.54)

### Short Position

Indicative SSL=open·price+{[((Investment amount/Units/IPC)*Account Exchange rate)+cumulative adjustment per unit]*configured SSL %}

ROUNDDOWN (EX. VOD SSL=101.53116 or 101.53678, rounddown 101.53)

Optionally, the user interface may permit the removal of the standard stop loss inherent in the CFD subject to payment of a fee.

The Guaranteed Stop Loss level is set at 100% of the Adjusted Purchase Price, which is when the Value of Position is nil.

The Guaranteed Stop Loss level will be triggered when there is a large movement in the price of the security and the price gaps between the level of the standard stop loss and the guaranteed stop loss.

The Sale Price is calculated by reference of the stop price which can be any price above the Guaranteed Stop Loss level. Note that the Sale Price of a Premium CFD can not be less then zero.

As trading is by way of purchasing a position and the selling of a purchased position, there is no requirement to send any margin calls as the positions do not operate by the payment of margin.

### Financing

Various options may be made available for financing open positions.

Charging Financing, the model typically used for Margin CFD's is not appropriate as we have to assume that financing charges can not be debited from the client account as additional funding may not be available for these charges.

When a rolling cash Premium CFD position is held over the end of day cut off, it is liable for financing. If the position is long, the account is charged; if the position is short, the account is paid (receives). This process is similar to that used for CFD financing. However, there is one significant difference. Instead of the account being debited or credited a cash amount representing the payment/charge, it's opening price for the position going into the next day is adjusted to reflect the payment/charge. This happens because the financing payment/charge then becomes part of the account's trading profit/loss.

NB. The financing only happens on rolling cash positions and the adjustments are made to the opening price for the next day, not the closing price for the current day.

The financing process is best illustrated with an example:

Client finishes day 1—long 2,000 share CFD VOD Cash at a price of 135.00 after mark to market. VOD Cash financing adjustment is 0.02 per share. Clients statement for day 1 shows his position valuation price calculated at the price of 135.00. The statement also shows that his financing adjustment for VOD Cash is 0.40, being the adjustment per share times the leverage factor.

VOD Cash closes at 136.00 on day 2.

Client statement for day 2 shows his start of day position as long 2,000 shares and an adjustment value of +0.40.

Client has done no trading and position mid closing price is 136.00.

Client Value Of Position on day 2=2000*(136.00−0.40)/20*0.01=GBP 135.60

If the financing adjustment had not been made, client Value of Position would have been 2000*136.00/20*0.01=GBP 136.00. Therefore, the financing adjustment has cost the client 40 p and it has been charged on the second day—exactly the same as CFD financing.

So to summarise:

For rolling cash Premium CFD positions, start of day positions =close price+financing adjustment.

It will be necessary to assign different financing profiles to allow clients to receive preferential rates, same as in CFD's.

### Financing Adjustments

### (a) Share and Index Markets

The financing adjustment for share and index Premium CFD Instruments will be calculated automatically using the following formulae:

### Adjustment for Long Positions

(([Close Price]×([Financing Rate]+[Long Haircut])/100)/[No of Days In underlying CFD Currency Year])×[No of Days to roll]×[Leverage Factor]

### Adjustment for Short Positions

(([Close Price]×([Financing Rate]−[Short Haircut])/100)/[No of Days In underlying CFD Currency Year])×[No of Days to roll]×[Leverage Factor]

[Financing Rate]—This is the overnight financing rate which changes every day. The previous day's value will be the default, it can be changed and must be verified.
[Long Haircut]—Haircut for long positions. The previous day's value will be the default, it can be changed and must be verified
[Short Haircut]—Haircut for short positions. The previous day's value will be the default, it can be changed and must be verified.
[No of Days To Roll]—By default this is will be 1. However if the following day is a non-trading day (e.g. Weekend or worldwide holiday) the default value will increment by 1 day until a valid trading day is reached. For example, Friday's value will always default to 3.

### [Leverage Factor]—For Equities use 10, for Index, Bullion and FX use 50, for Commodities use 20

Adjustment will be calculated to a maximum of 8 decimal places.

A different set of adjustment will be calculated per currency.

### EXAMPLE

Calculating the financing adjustment for 1 day VOD (UK) Premium CFD in GBP Close price=135.00, Financing rate=5.5815, Haircuts are 1.5 for longs, 2.5 for shorts, days in GBP year=365

Long adjustment=((135.00×(5.5815+1.5))/100/365×1×20=0.5238369

Short adjustment=((135.00×(5.5815−2.5))/100/365×1×20=0.2279465

### (b) FX and Bullion Instrument

The financing adjustments used for FX and bullion CFDs are identical to the tom/next swap values used by the FX rollover process. The swap value used in the FX rollover process are used as the rates for the relevant transaction size.

Note: Unlike shares and indices, FX adjustments can be negative, bullion adjustments are always positive

### (c) Other Instruments

All other CFD markets are to be quoted as future instruments, so there is no requirement for financing.

### Corporate Actions

We have to change how Corporate Actions is applied to open positions as we have to assume that Corporate Action charges can not be debited from the client account as additional funding may not be available for these charges.

The above discussed CFD's have exactly the same types of corporate action available as Margin CFD's. The only two differences between the two are:

1. Cash dispersions are modeled using price adjustments
2. Instruments selection will be done by selecting a base market, the corporate action will be applied to all tenors having that base market.

It is also important to note that, as with Margin CFD's, primary quantities must be multiples of 1 (calculations round down to the nearest multiple of 1) and if a corporate action results in a primary quantity of less than 1 will be rounded up to 1.

### (i) Cash Dispersion

Cash dispersions are modeled differently to Margin CFD's. Instead of making cash payments to/from client accounts, cash dispersions work in the same way as financing charges. A change to the opening price of affected positions is made after the End of Day. This places a major restriction on when cash dispersions can happen—they must take place as part of the End of Day process. Data entry will be identical to CFDs, however the weighting values relates to a percentage of the price, not a percentage of the paid dividend. It is important to note that cash dispersions only apply to spot Premium CFD instruments, future Premium CFD instruments are priced including dividends.

### EXAMPLE

Paying 90% of a 0.15 p dividend on VOD(UK) (close price=135.00)

Data entered will be identical to how it would be on CFD's:

Adjustment=[Weighing factor]×[Dividend value]×[Leverage Factor]

As the weighting is 90%, the actual adjustment required is 0.9×0.15×20=2.7

The adjustment to the Closing Price is negative for long positions and positive for short positions.

All other corporate actions are identical to CFD's. Possible modifications

### OPTIONAL VARIATIONS ON EMBODIMENTS

Although the above discussion has been limited to CFD products, it will be appreciated that the techniques would apply to other structured products. These could be traded on a regulated exchange and may displace traditional share trading and futures trading.

It is expected that the leverage factor for each product will be managed by the offering company to determine the purchase price. Due to this, the client will have to accept the levels of the standard and guaranteed stop levels which are inherent in the security purchased and will be unable to choose their own stop levels.

In a preferred embodiment, facilities may be provided via the user interface module 25 to enable clients to choose their own guaranteed stop loss level by providing them with the ability to “top-up” their original purchase price. This would be done by paying an additional premium to extend the standard and guaranteed stop levels to their requirements. In this manner, any increase in volatility of the security does not close the position due to a stop order being too close to the market levels.

Clients will be able to choose this option once they have made their initial purchase from the open positions blotter by hitting a “Top Up” button on the user interface module 25. A ‘top-up’ is a new type of order. A request for a ‘top-up’ order can be made at any time until the position is closed or a stop loss order has been triggered. A ‘top-up’ order can only be made on an open purchased security. Once any security is closed, by client or on reaching the stop level, no ‘top-up’ facility will be available.

This ‘top-up’ order is designed to extend the downside of a CFD trade. The client has to pay a premium for using it, and can be any amount chosen by the client. The premium will be debited immediately from the client account on acceptance of the order.

The acceptance of the ‘top-up’ order will result in the increase of the distance for the standard stop loss and guaranteed stop loss levels, inherent in the initial trade. The increase in the distance will be relative to the original purchase price level and not a factor of the market level at the time of the order being placed.

### EXAMPLES

### Equities—Long Trade

Client buys 2,000 shares VOD N-M CFD, share price quoted as 135.80−136.00.

Purchase Price=6.8 p per share or Initial Purchase Price is GBP 136.00 for 2000 shares.

Therefore, Initial Standard Stop Loss level=131.92 and Guaranteed Stop Loss level=129.20

If we assume that the client would like a ‘top-up’ order for GBP 50.00 then:

Then Standard Stop Loss and Guaranteed Stop Loss levels are lowered by 2.50 p per share.

(being 6.8 p×50/136)

Hence, New Standard Stop Loss level=129.42 and Guaranteed Stop Loss level=126.70

### Equities—Short Trade

Client sells 2,000 shares VOD N-M CFD, share price quoted as 135.80−136.00.

[PurchasePrice=Units*OpeningPrice/Leverage*InstrumentPointConvention]

Purchase Price=6.79 p per share or Initial Purchase Price is GBP 135.80 for 2000 shares.

Therefore, Initial Standard Stop Loss level=139.87 and Guaranteed Stop Loss level=142.59

If we assume that the client would like a ‘top-up’ order for GBP 75.00 then:

Then Standard Stop Loss and Guaranteed Stop Loss levels are increased by 3.75 p per share.

(being 6.79 p×75/135.8)

Hence, New Standard Stop Loss level=143.62 and Guaranteed Stop Loss level=146.34

### FX—Long Trade

Client buys 100,000 GBPUSD @ 1.9000

[PurchasePrice=Units/Leverage]Always in the currency of the first currency

Purchase Price=100,000/50 GBP=GBP 2,000 or USD 3,800 (0.0380 per unit)

Therefore, Initial Standard Stop Loss level=1.8696 and Guaranteed Stop Loss level=1.8620

If we assume that the client would like a ‘top-up’ order for GBP 500.00 then:

Then Standard Stop Loss and Guaranteed Stop Loss levels are lowered by 0.0095 per unit.

(being 0.0380×500/2000)

Hence, New Standard Stop Loss level=1.8601 and Guaranteed Stop Loss level=1.8525

### FX—Short Trade

Client sells 100,000 GBPUSD @ 1.9000

[PurchasePrice=Units/Leverage]Always in the currency of the first currency

Purchase Price=100,000/50 GBP=GBP 2,000 or USD 3,800 (0.0380 per unit)

Therefore, Initial Standard Stop Loss level=1.9304 and Guaranteed Stop Loss level=1.9380

If we assume that the client would like a ‘top-up’ order for GBP 750.00 then:

Then Standard Stop Loss and Guaranteed Stop Loss levels are lowered by 0.0142 per unit.

(being 0.0380×750/2000)

Hence, New Standard Stop Loss level=1.9446 and Guaranteed Stop Loss level=1.9522

In one embodiment of the present invention, a facility for ‘cash back’ is provided. This is an enhancement to enable clients to choose their own guaranteed stop loss level by providing them with the ability to take a portion of their investment out from the original purchase price by taking back a part of the premium to reduce the standard and guaranteed stop levels to their requirements.

Clients can have ‘Cash Back’ from their purchase price plus any profits less any losses for any open position. Clients will be able to choose this option once they have made their initial purchase from the open positions blotter by hitting the ‘Cash Back’ button. A ‘Cash Back’ is treated as a new type of order.

A ‘Cash Back’ order can only be made on an open purchased security. Once any security is closed, by client or on reaching the stop level, no ‘Cash Back’ facility will be available.

A request for a ‘Cash Back’ order can be made at any time until the position is closed or a stop loss order has been triggered.

The acceptance of the ‘Cash Back’ order will result in the decrease of the distance for the standard stop loss and guaranteed stop loss levels, inherent in the initial trade. The decrease in the distance will be relative to the original purchase price level and not a factor of the market level at the time of the order being placed.

### Calculating the Cash Back Amount:

Short names: CB—CashBack, PTR: Pre trade risk, Revised SSL:SSL after cash back, I.A.—

### Investment Amount

The max cash back would be pnl plus nearly half of their investment amount.

FX

Max cash back available=current valuation−[(quantity/(2*leverage factor))*spot offer exchange rate].

PTR: cash back allowed only if [(quantity*spot offer exchange rate)/(current valuation−cash back amt)]<=(2*leverage factor)

### Index/Commodity/Equity

Max cash back available=current valuation−[((quantity*open price*IPC)/(2*leverage factor))*spot offer exchange rate]

PTR: cash back allowed only if [(quantity*open price*IPC*spot offer exchange rate)/(current valuation−cash back amt)]<=(2*leverage factor)

The max cash back amount needs to be shown & validated as a truncated number not rounded number. Ex. Lets say calculated max cashback amount is 202.71 but should be shown and validated as 202.00.

On valid cash back confirmation,
1. Revise IA (IA-CB)
2. If Revised IA is >0, calculate ssl on Revised IA (standard ssl formula)
3. If Revised IA<−0, snapshot of valuation after CB and market price at which CB happened should be taken. These should be applied for ssl & gsl calculation.

This is best demonstrated by way of an example.

### EXAMPLES

| ASSUMPTIONS: | LEVERAGE | STD STOP LEVEL |
|---|---|---|
| FX, Bullion & Index | 50x | 2% of purchase price |
| Shares | 10x | 40% of purchase price |
| Commodities | 20x | 10% of purchase price |

### Equities—Long Trade

Client buys 2,000 shares VOD N-M CFD, share price quoted as 135.80−136.00.

Purchase Price=6.8 p per share or Initial Purchase Price is GBP 136.00 for 2000 shares.

Therefore, Initial Standard Stop Loss level=131.92 and Guaranteed Stop Loss level=129.20

If we assume that the client would like a ‘Cash Back’ order for GBP 50.00 then:

Then Standard Stop Loss and Guaranteed Stop Loss levels are increased by 1.50 p per share.

(being 6.8 p×50/136)×60%

Hence, New Standard Stop Loss level=133.42 and Guaranteed Stop Loss level=131.70

Equities—Short Trade

Client sells 2,000 shares VOD N-M CFD, share price quoted as 135.80-136.00.

[PurchasePrice=Units*OpeningPrice/Leverage*InstrumentPointConvention]

Purchase Price=6.79 p per share or Initial Purchase Price is GBP 135.80 for 2000 shares.

Therefore, Initial Standard Stop Loss level=139.87 and Guaranteed Stop Loss level=142.59

If we assume that the client would like a ‘Cash Back’ order for GBP 75.00 then:

Then Standard Stop Loss and Guaranteed Stop Loss levels are decreased by 2.25 p per share.

(being 6.79 p×75/135.8)×60%

Hence, New Standard Stop Loss level=142.12 and Guaranteed Stop Loss level=144.84

### FX—Long Trade

Client buys 100,000 GBPUSD® 1.9000

[PurchasePrice=Units/Leverage]Always in the currency of the first currency

Purchase Price=100,000/50 GBP=GBP 2,000 (0.02 per unit) or USD 3,800 (0.0380 per unit)

Because of exchange rate movements, we can not exactly determine the Guaranteed Stop Level (GSL) as in this example the GSL would have been 1.8620. The USD loss at this level would be USD 3,800, which converted to GBP at 1.8620 would result in a loss of GBP 2,040.81 which is greater then the original investment of GBP 2000.

So in order to get a more accurate GSL, we need to discount the original calculated level by a factor of 98%.

Therefore, Initial Standard Stop Loss level=1.8634 and Guaranteed Stop Loss level=1.8627

If we assume that the client would like a ‘Cash Back’ order for USD 500.00 then:

Then Standard Stop Loss and Guaranteed Stop Loss levels are lowered by 0.0049 per unit.

(being 0.0380×50013800)×98%

Hence, New Standard Stop Loss level=1.8585 and Guaranteed Stop Loss level=1.8578

### FX—Short Trade

Client sells 100,000 GBPUSD @ 1.9000

[PurchasePrice=Units/Leverage]Always in the currency of the first currency Purchase Price=100,000/50 GBP=GBP 2,000 or USD 3,800 (0.0380 per unit)

Therefore, Initial Standard Stop Loss level=1.9304 and Guaranteed Stop Loss level=1.9380

If we assume that the client would like a ‘Cash Back’ order for USD 750.00 then:

Then Standard Stop Loss and Guaranteed Stop Loss levels are lowered by 0.0074 per unit.

(being 0.0380×750/3800)×98%

Hence, New Standard Stop Loss level=1.9378 and Guaranteed Stop Loss level=1.9454

### Client Side Functionality:

This ‘Cash Back’ order is designed to reduce the downside of a Premium CFD trade. The client has to receive part of the premium plus any profits less any losses for using it, and can be any amount chosen by the client subject to PTR checks as noted below. The premium will be credited immediately to the client account on acceptance of the order input via the user interface module 25.

The effect of accepting the order will be to move the levels of both the standard stop loss and the guaranteed stop loss by the amount of the ‘Cash Back’.

In placing a ‘Cash Back’ order, the client places an Order to move the stops for the open position for the same quantity. This order can only be executed or cancelled by the dealer.

When the ‘Cash Back’ order is executed, the client will receive a confirmation, for standard and guaranteed Stops being reduced. The purchase price will be decreased by the amount of the ‘Cash Back’ to reflect the return of some of the premium paid for the security.

There are two ways in which a position can be closed, these are:
The Stop is Triggered
The price hits or goes through the standard stop price or the guaranteed stop price, then the stop will be triggered. If the price only goes through the standard stop price and not the guaranteed stop price, then the fill will be at the market price if the price has moved through the standard stop price. If the price goes through both, the standard stop price and the guaranteed stop price, then the closing price is at the guaranteed stop price. They can not fill it at the market price if the price has moved through the guaranteed stop. As such, if a standard stop is at 2045 and a guaranteed stop is placed at 2040, the market is at 2048, but the drops to 2038, the stop price will still be filled at 2040. As such the client is protected from the market gapping.
The Client closes the trade
The client selects to close the trade from their open positions window in the user interface module 25. The ticket that is displayed will have an option to close out the trade. If they select this, then it will be treated like any other market order.

### Pre-Trade Risk (PTR)

For ‘Cash Back’ trade—Sufficient headroom must be available for the full price in order to execute a ‘Cash Back’ order.

In order to determine if sufficient headroom is available, we must calculate that the Guaranteed Stop Value is away from the current price by a minimum leverage factor of two times the standard leverage factor. E.g. if the standard leverage factor is 50 then the minimum leverage factor should be 100. So if the ‘Cash Back’ amount causes the leverage factor to be above 100 then the request for the Cash Back order will be declined.

As with the purchase price for positions for ‘Cash Backs’, the currency will be in the account currency.

### Valuation/Sale Price Pre Top-Up

All Valuations and Sale Price are calculated in the normal way:

$$ValueOfPositions = NetUnits * ( PurchasePricePerUnit + ProfitPerUnit + AdjustmentPerUnit ) * InstrumentPointConvention$$

### VALUATION/SALE PRICE POST CASH BACK

All Valuations and Sale Price are calculated as follows way:

$$ValueOfPositions = NetUnits * ( PurchasePricePerUnit + ProfitPerUnit + AdjustmentPerUnit ) * InstrumentPointConvention$$

### General

Every Cash Back order will be automatically accepted by the system.

Dealer Application will provide a Cash Back deal history of all Cash Back accepted.

### Confirmations

On acceptance of a Cash Back order type from a client, the following confirmations may be offered:
1. Pop-up window on client front-end application
2. Email confirmation
3. Client Statement confirmation

All Confirmations types will typically include the following information:
Deal No.
Time
Original Investment
Currency
Amount
Revised Indicative Standard Stop Loss Level

While the invention has been described in connection with a certain embodiment thereof, the invention is not limited to the described embodiments but rather is more broadly defined by the recitations in the claims below and equivalents thereof.

1. A management system for contract for difference trading comprising:
a user interface module and a processing module,
the user interface module including computer program code for receiving user inputs on a purchase or sale of a contract for difference and computer program code for communicating data to the processing module in dependence on said user inputs;
the processing module comprising a machine executing computer program code that is arranged to receive the data communicated from the user interface,
wherein if the data concerns a purchase, the computer program code is arranged to debit a financial account for the value of the contract for difference to be purchased, if the data concerns a sale, the computer program code is arranged to credit a financial account for the value of the contract for difference to be sold.

2. A management system as claimed in claim 1, wherein:
the processing module further comprises computer program code that is arranged to obtain security pricing data from a data source, computer program code that is arranged to calculate contract for difference value data in dependence on the obtained security pricing data, and computer program code that is arranged to communicate the calculated contract for difference value data to the user interface module; and,
the user interface module further comprises computer program code for communicating with the processing module for receiving the contract for difference value data on securities from the processing module and computer program code for displaying a user interface to a user including the value data.

3. A management system as claimed in claim 2, further comprising a data repository, the data repository comprising a data store for storing data on a user account and on a purchased contract for difference associated with the user account, wherein the processing module is arranged to store or update data in said data repository in dependence on said data received from the user interface.

4. A management system as claimed in claim 3, wherein the data repository is arranged to store data on a stop loss level for a contract for difference, the processing module further comprising computer program code for calculating the value of the purchased contract for difference in dependence on the value data and computer program code for closing the purchased contract for difference if said value is less than or equal to the stop loss level.

5. A management system as claimed in claim 4, wherein the user interface module includes computer program code for accepting a change to the stop loss level and computer program code for communicating data on said change to the processing module, the processing module further comprising computer program code for updating the stored stop loss level data in the repository in dependence on the data from the user interface and computer program code for crediting or debiting said financial account in dependence on said change.

6. A management system as claimed in claim 5, wherein the computer program code for accepting a change includes computer program code for displaying a funds withdrawal user interface element in association with a purchased contract for difference and computer program code for receiving a user input to the funds withdrawal user interface element requesting funds withdrawal from the associated contract for difference.

7. A management system as claimed in claim 5, wherein the computer program code for accepting a change includes computer program code for displaying an additional funding interface element in association with a purchased contract for difference and computer program code for receiving a user input to the additional funding interface element designating additional funding for the associated contract for difference.

8. A management system as claimed in claim 4, wherein the data repository stores data on a global stop loss level that applies to all of an account's contracts for difference unless wherein the user interface module includes computer program code for accepting a user input to set an individual stop loss level for a contract for difference, said individual stop loss level overriding the global stop loss level.

9. A management system as claimed in claim 4, wherein the user interface module includes computer program code for displaying a stop loss disable user interface element in association with a purchased contract for difference and computer program code for accepting a user input to the stop loss disable user interface element and for communicating data on said user input and said associated contract for difference to the processing module, the processing module further comprising computer program code for receiving said data on said user input and on said associated contract for difference, computer program code for applying a charge to said financial account and computer program code for removing or disabling said stop loss level for the contract for difference in said data repository.

10. A management system as claimed in claim 3, wherein the processing module further comprises computer program code for adjusting data on a contract for difference held open after an end of day cut-off time, said adjustment being operative to reduce a next day opening value for the contract for difference in dependence on a predetermined charge.

11. A management system as claimed in claim 1, further comprising a web server hosting the user interface.

12. A management system as claimed in claim 1, further comprising a network interface coupled to the processing module, wherein the user interface is remote of the processing module and is arranged to communicate with the processing module via the network interface over a data communications network.
